(19) United States
(12) Patent Application Publication
(10) Pub. No.: US 2011/0165806 A1
(43) Pub. Date: Jul. 7, 2011

(54) FABRIC FOR AIRBAG AND METHOD OF PREPARING THE SAME

(75) Inventors: Young-Jo Kim, Gimpo-si (KR); Yun-Jo Kim, Gumi-si (KR); Young-Soo Lee, Gumi-si (KR)

(73) Assignee: KOLON INDUSTRIES, INC., Kwacheon-city, Kyungki-do (KR)

(21) Appl. No.: 13/061,866

(22) PCT Filed: Sep. 7, 2009
(86) PCT No.: PCT/KR2009/005047

§ 371 Date: Mar. 2, 2011

(30) Foreign Application Priority Data
Sep. 5, 2008 (KR) 10-2008-0087734
Sep. 7, 2009 (KR) 10-2009-0083887

(51) Int. Cl. D03D 1/02; D03D 15/00; B60R 21/235

(52) U.S. Cl. 442/60; 442/195; 264/103

(57) ABSTRACT

The present invention relates to a fabric for an airbag, in particular, a fabric for an airbag comprising the polyester fiber, and a method of preparing the same. The fabric for the airbag according to the present invention is prepared by using a polyester fiber having the cross-section thereof in a flat shape, and there are advantages in that the present fabric is thinner than the fabric made of the circular cross-sectional fiber. It is possible to reduce the amount of the coating resin used and to lighten the weight of the product because of the low surface irregularity and the porosity. Also, the present fabric is superior in tensile strength, tearing strength, air permeability, and the folding property in a module system of the airbag apparatus.

### CROSS REFERENCES TO RELATED APPLICATION

This application claims priority to and the benefit of Korean Patent Application No. 10-2008-0087734 filed in the Korean Industrial Property Office on Sep. 5, 2008 and No. 10-2009-0083887 filed in the Korean Industrial Property Office on Sep. 7, 2009, which are hereby incorporated by reference for all purpose as if fully set forth herein.

### BACKGROUND OF THE INVENTION

(a) Field of the Invention

The present invention relates to a fabric for an airbag, which comprising a polyester fiber, and a method of preparing the same.

(b) Description of the Related Art

Generally, an airbag is the device that protects a driver and passengers. When a car collides head-on at 40 km/h or more, an impact sensor of the airbag reacts to collision and makes a powder explosion. It puts gas into inside of the airbag and makes the airbag expand.

The fabric for an airbag demands a low air permeability to expand quickly by an explosive gas and discharge the gas in a short time, a mechanical property such as a high strength and a high heat-resistance to prevent the damage and the explosion of the airbag itself, and a softness to minimize the impact to passengers, etc.

Particularly, the airbag including the fabric is unfolded from the side window or in the front interior side of a vehicle during an accident, in order to protect a driver's or a passenger's head from being injured by the window or side frame of the vehicle when the vehicle overturns and rolls over. Thus, the airbag should maintain the inflated state for a minimum required time when the vehicle rolls over, in order to protect a passenger safely during the accident, and the low air permeability of the fabric is important for the airbag

However, the fabric for an airbag, that has an excellent capacity of keeping an internal gas pressure to the extent of protecting passengers and an excellent mechanical property for standing against the impact to the airbag during the accident, has not been provided nor suggested. The fabric, which can be used with outstanding reliability under the severe conditions in a vehicle, has not been suggested neither.

A polyamide fiber such as nylon 66 has been used for preparing an ordinary airbag fabric, since nylon 66 has a good impact resistance. However, nylon 66 is deteriorated in a moisture resistance and a light resistance comparing with those of a polyester fiber, and the cost for preparation is expensive.

In order to diminish the defects occurred in case of using the polyamide fiber, JP Patent Publication No. 04-214437 discloses a polyester fiber to be used for preparing an airbag fabric. However, there are some problems in that the prepared fabric does not have a folding property and an impact resistance suitable for the airbag.

Therefore, it is required that a study for developing a fabric for an airbag, which has an excellent capacity of keeping an internal gas pressure to the extent of protecting passengers at rollover, a softness to minimize the impact to passengers, and a mechanical strength to stand against the impact to the airbag.

### SUMMARY OF THE INVENTION

The present invention is to provide a fabric for an airbag including the flat polyester fiber.

The fabric for an airbag according to the present invention has an excellent capacity of keeping an internal gas pressure when developing the airbag, simultaneously with improved softness and folding properties, by using a flat polyester fiber having good smoothness and a uniform structure with improved shrinkage stress and shrinkage rate.

Also, the present invention is to provide a method of preparing the fabric for an airbag.

The present invention provides a fabric for an airbag comprising the polyester fiber, wherein the flatness of the cross-section of the polyester fiber is from 1.3 to 3.0 and a coefficient of variation (CV %) of R1 to R4 in the total filaments of the polyester fiber is 20% or less, with provision that both end points of the longest axis of the cross-section are defined as W1 and W2, both end points of the shortest axis perpendicularly crossing the longest axis at a center point O of the longest axis are defined as D1 and D2, a line between W1 and D1 is defined as L1, a line between D1 and W2 is defined as L2, a line between W1 and D2 is defined as L3, a line between W2 and D2 is defined as L4, a perpendicular distances from L1, L2, L3, and L4 to the farthest line of the cross-section are defined as R1, R2, R3, and R4, respectively, and a perpendicular distances from L1, L2, L3, and L4 to the center point O are defined as H1, H2, H3, and H4, respectively.

The present invention also provides a fabric for an airbag comprising the polyester fiber, wherein flatness of the cross-section of the polyester fiber is from 1.3 to 3.0, shrinkage stress (@ 0.1 g/d, 2.5° C./sec) at 150° C. is from 0.005 to 0.1 g/d, shrinkage stress (@ 0.1 g/d, 2.5° C./sec) at 200° C. is from 0.005 to 0.1 g/d, and shrinkage rate (@ 190° C., 15 min, 0.01 g/d) is from 1.5% to 10.0%.

The present invention also provides a method of preparing a fabric for an airbag, comprising the steps of melt-spinning polyester chips through slit-typed capillaries and drawing the melt-spun fiber to prepare a polyester fiber having the flatness of the cross-section thereof from 1.3 to 3.0, weaving a fabric with the polyester fiber, scouring the woven fabric, and tentering the scoured fabric.

### BRIEF DESCRIPTION OF THE DRAWINGS

FIG. 1 is a schematic drawing showing one example of the cross-section of the polyester fiber used for an airbag fabric of the present invention.

FIG. 2 is a schematic process diagram showing the process of preparing the polyester fiber used for an airbag fabric of the present invention.

FIG. 3 is a schematic plane drawing showing one example of the die used in the present spinning process.

FIG. 4 is a schematic drawing of a cross-section of the die used, showing a capillary of the die.

FIG. 5 is a schematic cross-sectional drawing showing one example of the spinning pack used in the present spinning process.

FIG. 6 is a bottom view drawing showing one example of the dispersing plate used in the present spinning process.

FIG. 7 is a cross-sectional drawing showing one example of the dispersing plate used in the present spinning process.

FIG. 8 is a schematic drawing showing an interlacer that provides interlacing air to the fiber in the direction perpendicular to the running direction of the fiber.

FIG. 9 is a schematic drawing showing an interlacer that provides interlacing air to the fiber in the inclined direction with respect to the running direction of the fiber.

FIG. 10 is a schematic process diagram showing a case of using a second interlacer and an after-oiling apparatus together.

FIG. 11 is an optical microscopic photograph showing the cross-section of the flat cross-sectional fibers prepared according to the present Example 1.

### DETAILED DESCRIPTION OF THE EMBODIMENTS

Hereinafter, the fabric for an airbag according to detailed embodiments of the present invention and the method of preparing the same are explained in more detail. However, they are merely presented as an example of the present invention, and thus it is clearly understood to a person skilled in the art that the scope of the present invention is not limited to the detailed embodiments and various modifications and executions are possible according to the embodiments within the scope of the present invention.

The fabric for an airbag according to the present invention comprises a polyester fiber, wherein the flatness of the cross-section of the polyester fiber is from 1.3 to 3.0 and a coefficient of variation (CV %) of R1 to R4 in the total filaments of the polyester fiber is 20% or less, with provision that both end points of the longest axis of the cross-section are defined as W1 and W2, both end points of the shortest axis perpendicularly crossing the longest axis at a center point O of the longest axis are defined as D1 and D2, a line between W1 and D1 is defined as L1, a line between D1 and W2 is defined as L2, a line between W1, and D2 is defined as L3, a line between W2 and D2 is defined as L4, a perpendicular distances from L1, L2, L3, and L4 to the farthest line of the cross-section are defined as R1, R2, R3, and R4, respectively, and a perpendicular distances from L1, L2, L3, and L4 to the center point O are defined as H1, H2, H3, and H4, respectively.

Firstly, in the present invention, a fabric for an airbag is a textile fabric or a nonwoven fabric which is used for preparing an airbag. The ordinary fabric for an airbag is a textile fabric or a nonwoven fabric manufactured from nylon 66 or nylon 6, if necessary, by using a Rapier loom. However, the fabric for an airbag according to the present invention is characterized by using a flat polyester fiber.

Particularly, the fabric for the airbag according to the present invention is prepared by using a polyester fiber having the cross-section thereof in a flat shape, and there are advantages in that the present fabric is thinner than the fabric made of the circular cross-sectional fiber. It is possible to reduce the amount of the coating resin used and to lighten the weight of the product because of the low surface irregularity and the porosity. Also, the present fabric has an improved folding property and an excellent capacity of keeping an internal gas pressure for developing the airbag.

The fabric for an airbag of the present invention is superior in the shape stability and the air permeability of the airbag than the fabric made from nylon 66 or nylon 6, in especial, after storing in a long period. Also, the fabric prepared from the polyester fiber according to the present invention has advantages of the excellent folding property in a module system of the airbag apparatus and the improved softness to minimize the impact to passengers, since the polyester polymer does not have a hydrogen bond in the polymer ring.

The fabric for an airbag of the present invention is preferable to have a tensile strength from 190 to 280 kgf/inch measured by ASTM (American Society for Testing and Materials International) D 5034 GRAB, and more preferably 220 to 270 kgf/inch. In particular, the tensile strength may be measured by using a 49×49 coated fabric. In order to obtain the shape stability and the mechanical property of the airbag, when developing the airbag, it is preferable that the tensile strength of the fabric is 190 kgf/inch or more in the atmosphere conditions, and 160 kgf/inch or more after performing an aging process (cycle aging, heat aging, or humidity aging).

Furthermore, the fabric for an airbag is required to have an excellent tearing strength owing to a high temperature and high pressure gas injected into inside of the airbag for expanding the airbag. The fabric for an airbag of the present invention is preferable to have a tearing strength from 23 to 50 kgf measured by ASTM (American Society for Testing and Materials International) D 2261-TONGUE, and more preferably 28 to 45 kgf. In case that the tearing strength of the fabric is less than 23 kgf, the fabric may be exploded when the airbag spreads out, and thus the serious danger may be caused to protect a driver and passengers.

As described above, the fabric for the airbag according to the present invention is prepared by using a polyester fiber having the cross-section thereof in a flat shape, and there are advantages in that the present fabric is thinner to have a superior folding property than the fabric made of the circular cross-sectional fiber. In particular, the thickness (T) of the fabric for the airbag is preferable 95% or less comparing with the thickness (t) of the fabric prepared from the ordinary circular cross-sectional fiber, and more preferably 93% or less, or 70% to 93%. Thus, the thickness of the present fabric is thinner than those of the fabric made of the circular cross-sectional fiber. It is possible to reduce the amount of the coating resin used and to lighten the weight of the product because of the low surface irregularity and the porosity. Also, the present fabric is superior in the folding property and the packaging property in a module system of the airbag apparatus.

The fabric for an airbag of the present invention is preferable to have the air permeability from 0 to 10.0 cfm measured by ASTM (American Society for Testing and Materials International) D 5034 GRAB in the condition that the difference of the air pressures is 125 Pa. More preferably, the air permeability of the fabric is 5 cfm or less in order to have an excellent capacity of keeping an internal gas pressure when developing the airbag

In comparison with prior methods of preparing industrial polyester fiber, the polyester fiber, which is used to prepare the fabric for an airbag of the present invention, is characterized in that the thickness, the surface irregularity, and the porosity of the fabric made of the fiber are lessened by making the cross-section of the fiber to be flat compared with prior circular by adopting slit-type capillaries in the die.

As described above, the present invention is also characterized in that the shape stability is optimized when the fiber is applied to the fabric for an airbag by managing the figural characteristics, the shrinkage stress, and the shrinkage rate of the fiber having a flat cross-section, and problems such as abnormal shrinkage are resolved.

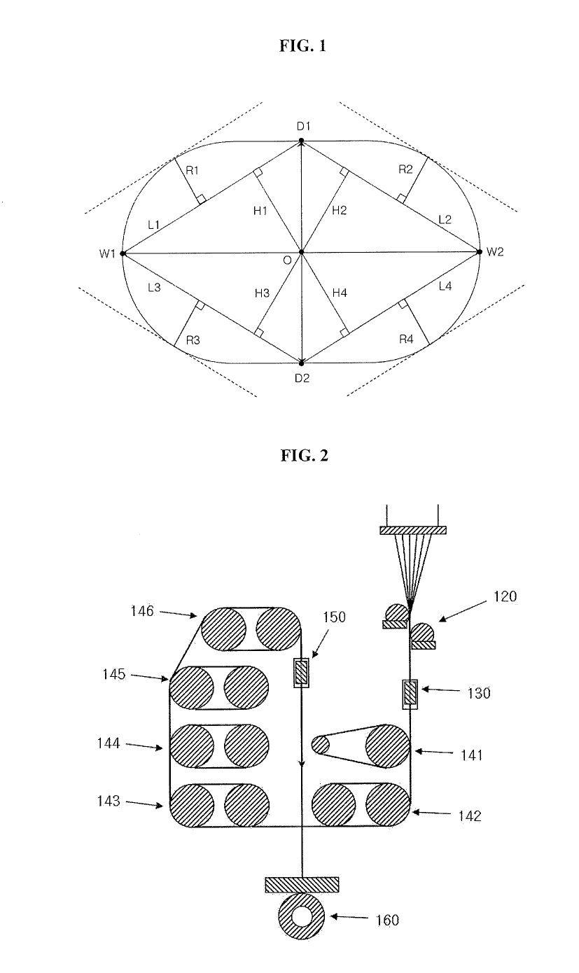

FIG. 1 is a schematic drawing showing one example of the cross-section of the polyester fiber used for preparing the fabric for an airbag of the present invention. As illustrated in FIG. 1, it is preferable that the flatness of the polyester fiber, i.e., the aspect ratio of the polyester fiber, which is defined as a ratio of the length of the longest axis (W1-W2)/the length of the shortest axis (D1-D2), is from 1.3 to 3.0.

Also, it is preferable that the coefficient of variation (CV %) of R1 to R4 is 20% or less, when both end points of the longest axis of the cross-section are defined as W1 and W2, both end points of the shortest axis perpendicularly cross the longest axis at the center point O of the longest axis are defined as D1 and D2, the line between W1 and D1 is defined as L1, the line between D1 and W2 is defined as L2, the line between W1 and D2 is defined as L3, the line between W2 and D2 is defined as L4, the perpendicular distances from L1, L2, L3, and L4 to the farthest line of the cross-section are defined as R1, R2, R3, and R4, respectively, and the perpendicular distances from L1, L2, L3, and L4 to the center point O are defined as H1, H2, H3, and H4, respectively, in FIG. 1.

When the coefficient of variation (CV %) is over 20%, the properties and the cross-sectional shape of the fiber become irregular, and the processing workability and the quality may be affected as fiber breakage, partial deformation of the shape, or distortion of the fiber occurs.

Furthermore, it is preferable that the average of the length ratios defined as R1/H1, R2/H2, R3/H3, and R4/H4 in the cross-section is from 0.2 to 0.9. The shoulder parts of the fiber become bulky as the average of the length ratio increases, and the shoulder parts of the fiber become thin and it has an oval or diamond-shaped cross-section as the average of the length ratio decreases.

Also, it is preferable that the coefficient of variation (CV %) of R1/H1, R2/H2, R3/H3, and R4/H4 is 20% or less so that the flat cross-sectional fiber have stable properties can be produced. That is, the shape of the cross-section is twisted when the coefficient of variation of R1/H1, R2/H2, R3/H3, and R4/H4 is over 20%, and the properties of the fiber and the smoothness of the fabric made of the fiber deteriorate.

Furthermore, it is preferable that the shrinkage stress at 150° C., which corresponds to a laminate coating temperature for general coated fabrics, is from 0.005 to 0.1 g/d, and it is also preferable that the shrinkage stress at 200° C. corresponding to a sol coating temperature for general coated fabrics is from 0.005 to 0.1 g/d. That is, when the shrinkage stresses at 150° C. and 200° C. are at least 0.005 g/d, respectively, drooping of the fabric caused by the heat of the coating process may be presented, and when the stresses are 0.1 g/d or less, relaxation stress can be relieved during a cooling process at room temperature after the coating process.

It is also preferable that the shrinkage rate of the polyester fiber at 190° C. is 1.5% or more in order to maintain the woven shape as a fiber in the airbag by providing tension of over a certain level during the heat treating of the coating process, and it is also preferable that the shrinkage rate at 190° C. is 10.0% or less, more preferably 7.0% or less in order to secure thermal shape stability.

The shrinkage stress defined in the present invention is based on a value measured under a fixed load condition of 0.10 g/d, and the shrinkage rate is based on a value measured under a fixed load condition of 0.01 g/d.

Said polyester fiber is preferably a polyethylene terephthalate (PET) fiber among general polyesters, and it is more preferably a PET fiber including PET at 90 mol % or more.

It is preferable that the intrinsic viscosity of the fiber is 0.7 dl/g or more so that the polyester fiber has the shrinkage stress of 0.005 g/d or more, and that the intrinsic viscosity is 1.2 dl/g or less, and more preferably 1.0 dl/g or less, in order to obtain an excellent strength and shape stability.

Furthermore, in the preparing process of the polyester fiber, the present invention also has a characteristic in that it generates the following properties by providing interlacing air when the polyester fiber is passed through the pre-interlacer of the spinning process. Namely, it is preferable that the polyester fiber has fineness of the monofilament of 2.1 to 11.0 de which is equal to the fiber having the specific shape because an air having a direction in a certain range is provided to the pre-interlacer. Furthermore, the crystallinity is preferably 35% or more, and more preferably 35 to 52%, in order to maintain the thermal shape stability. Furthermore, the polyester fiber may have tensile strength of 7.0 to 10.0 g/d and elongation at break of 12 to 30% in order to secure the physical properties required as an industrial fiber.

The fiber for an airbag of the present invention comprises the polyester fiber having the above properties, and thus has high yield of the process when it is made into the fabric and coated with a resin. It is possible to prepare the fabric having good shape stability while decreasing the thickness of the fabric.

Furthermore, the fabric for the airbag according to the present invention may further include a resin layer(s) coated or laminated thereon. The resin layer may comprises at least one selected from the group consisting of silicone resin, polyvinyl chloride resin, polyethylene resin, and polyurethane resin, and the kinds of the coated resin are not limited to the above-mentioned materials. The resin layer may be formed by coating throughout the whole airbag fabric. The usual coating method, such as knife over roll coating, doctor blade coating, or spray coating, may be applied, and it is preferable to use knife over roll coating.

The coating amount of the resin layer is preferably 20 g/m² to 200 g/m², more preferably 20 g/m² to 100 g/m². In particularly, in case of an OPW (One Piece Woven) typed fabric for a side curtain airbag, the coating amount of the resin layer is preferably 30 g/m² to 95 g/m². In case of a plain weave fabric for an airbag, the coating amount of the resin layer is preferably 20 g/m² to 50 g/m².

Since the flat cross-sectional fiber included in the fabric of the present invention is superior in packing property, and its thickness is thin and the area covered by the fiber itself is large in comparison with general circular cross-sectional fiber, the fabric for an airbag of the present invention prepared from the fiber has advantages in that its thickness is thin, its pores are small, and its surface roughness is low, and thus it is possible to exhibit a superior coating property even with a small amount of the coating solution, and the inferior rate in the coating process is low when it is coated. Therefore, the fabric for an airbag of the present invention has an excellent capacity of keeping an internal gas pressure when the airbag spreads out.

The fabric for an airbag of the present invention may is formed of a plain weave or OPW (One Piece Woven), and the weaving type of the fabric is not limited to the above.

The fabric for an airbag according to the present invention may be prepared through ordinary beaming of weft and warp, weaving, scouring, and tentering process.

Especially, the method of preparing a fabric for an airbag according to the present invention comprises the steps of melt-spinning polyester chips through slit-typed capillaries and drawing the melt-spun fiber to prepare a polyester fiber having the flatness of the cross-section thereof from 1.3 to 3.0, weaving a fabric with the polyester fiber, scouring the woven fabric, and tentering the scoured fabric.

The fabric may be prepared by using an ordinary weaving apparatus, which usually used in a fabric for an airbag and are not limited to the specific apparatus. For example, the plain weaved fabric is obtained by using Rapier loom, Air jet loom or Water jet loom, and the OPW (One Piece Woven) fabric is obtained by using Jacquard loom.

The polyester fiber having a flat cross-section, which is used for the fabric of the present invention, may be prepared by melting polyester chips having an intrinsic viscosity of 0.7 to 1.2 dl/g at a spinning temperature of 270 to 310° C. and spinning it through slit-typed capillaries. The intrinsic viscosity of the chips is preferably 0.7 dl/g or more in order to prepare the fiber having desirable shrinkage stress and shrinkage rate, and the intrinsic viscosity is 1.2 dl/g or less in order to prevent breakage of the molecular chain due to the elevated melting temperature and the increase of the pressure in the spinning pack.

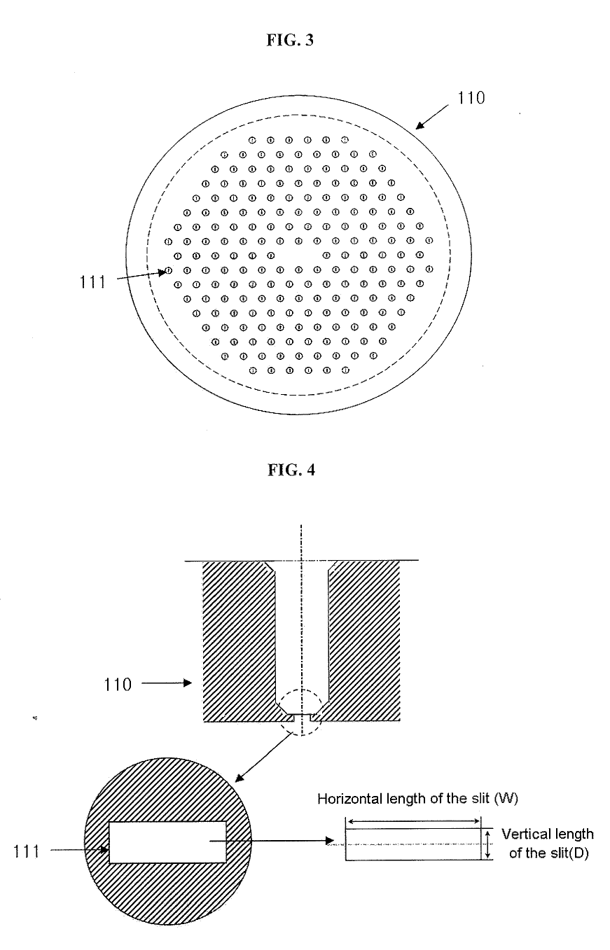

FIG. 2 is a schematic process diagram showing the process of preparing the polyester fiber for an airbag fabric of the present invention. As shown in FIG. 2, the preparing method of the fiber includes the steps of cooling the molten polymer spun through the spinning die with quenching-air, providing an oil to the undrawn fiber by using an oiling roll (120) (or an oil-jet), and dispersing the oil provided to the undrawn fiber onto the surface of the fiber uniformly by using a pre-interlacer (130) with regular air pressure. After this, the drawing process is carried out by passing the undrawn fiber through the multi-step drawing apparatuses (141-146), and then the present fiber is finally produced by intermingling the drawn fiber with regular pressure in the second interlacer (150) and winding it with a winder (160).

FIG. 3 is a schematic plane drawing showing one example of the die (110) that is used in the present spinning process. Referring to FIG. 3, a plurality of capillaries (111) are formed on the upper part of the present spinning die. The arranging type of the capillaries is not particularly limited, but it may preferably be a triangle type, a diamond type, or a circle type in which the capillaries are arranged with the same pitch of center distance (PCD).

FIG. 4 is a schematic drawing showing a capillary (111) of the die in a cross-sectional drawing of the die (110) used. As shown in FIG. 4, the cross-section of the discharged fibers becomes flat compared with prior circular by making the structure of the capillaries that discharge the liquefied polymer as a slit type.

In the shape of the slit of FIG. 4, the flatness can be particularly controlled by varying the ratio of the longest length (W) and the shortest length (D) of the slit, wherein the ratio of “W/D” is defined as a flatness of the die, and the flatness is preferably 1.2 or more, more preferably 2.0 or more in order to represent the characteristic of the flat cross-section and it is also preferably 10 or less in order to secure drawability and the high strength property.

Furthermore, the shear rate (sec⁻¹) that operates in the slit-typed die is preferably 1000 to 4500 sec⁻¹ in order to secure the uniform cross-section of the flat shape. When the shear rate is less than 1000 sec⁻¹, the cross-section becomes heterogeneous because the viscosity of the polymer seriously varies, and when it is over 4500 sec⁻¹, the spinning property may be poor because the viscosity excessively decreases.

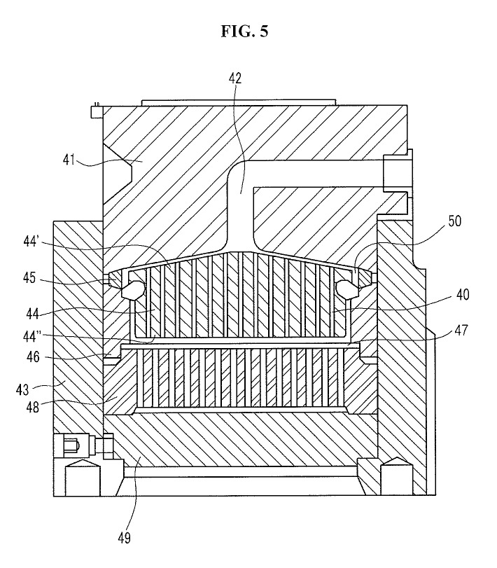

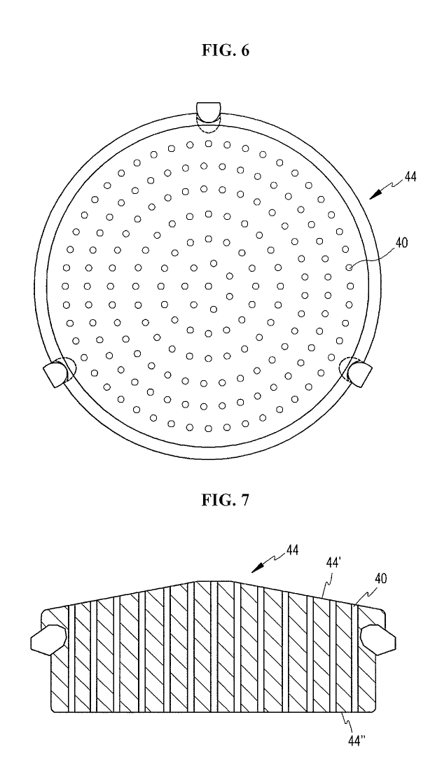

The spinning pack that spins the molten polymer into fibers is not particularly limited, but it is preferable to use a spinning pack having the construction as illustrated in FIG. 5. In the spinning pack apparatus applied to the present invention having the construction as illustrated in FIG. 5, a body (43) is connected to the lower part of a block (41) equipped with a polymer inlet (42), and, inside the body (43), a dispersing plate (44) having a dispersing surface (44′), a lens ring (45), a spacer (46), a filter (47) composed of a metal non-woven fabric, a dividing plate (48), and a die (49) are stacked in order in a state leading to the polymer inlet (42), and at least one polymer inflow hole (40) vertically perforated through the dispersing plate are formed on the dispersing plate (44) as shown in FIG. 6 and FIG. 7.

By maintaining the distance between the bottom (44″) of the dispersing plate (44) and the filter (47) at 4 to 44 mm, the stay time of the molten polymer passing through a polymer flowing path (50) of the outer side of the dispersing plate (44) and the stay time of the molten polymer passing through the polymer inflow holes (40) of the dispersing plate (44) may be maintained to be equal, and thus the total stay time may be shortened. The shape of the bottom (44″) of the dispersing plate (44) is also not particularly limited, but it may preferably be a plane-shape or a gentle cone-shape.

A polymer inflow hole is formed at the center of the dispersing plate, and the pitch of center diameter (PCD) between successive adjacent inflow holes is 5 to 40 mm, and it is preferable that the total area covered by the inflow holes per circle area covered by the outer line of the dispersing plate is 1 to 35%. It is very difficult to prepare a dispersing plate of which the PCD between the successive adjacent inflow holes is less than 5 mm, and the dispersibility of the polymer may deteriorate when the PCD is over 40 mm. Furthermore, when the total area covered by the inflow holes per total circle area of the dispersing plate is less than 1%, the dispersing plate cannot be applied to the present invention because deterioration of the dispersibility of the polymer and increase of pressure in the polymer spinning pack are caused, and when it is over 35%, the dispersing efficiency of the polymer in the spinning pack decreases.

While the molten polymer introduced into the polymer inlet (42) flows naturally down in accordance with the inclined angle of the cone-shaped dispersing surface (44′), a portion of the polymer flows into the polymer inflow holes (40) that are vertically perforated through the dispersing plate and the rest flows into the polymer flowing path (50) of the outer side, and the whole polymer is extruded through the filter (47), the dividing plate (48), and the die (49) in order and forms the fiber.

In the spinning pack apparatus of the present invention, when the molten polymer flows on the dispersing plate (44), the polymer flowing path (50) is farthest from the center peak of the dispersing surface (44′), whereas the length to the bottom (44″) of the dispersing plate (44) is shortest at the outer end of the dispersing surface (44′) because of the inclined angle of the dispersing plate (44′).

On the other hand, the polymer inflow holes (40) are closer to the center of the dispersing plate (44) than the polymer flowing path (50), whereas the distance to reach the bottom (44″) of the dispersing plate through the polymer inflow holes (40) is long.

Therefore, the stay time of the molten polymer reaching the dividing plate (48) through the polymer flowing path (50) and the stay time of the molten polymer reaching the dividing plate (48) through the polymer inflow holes (40) may be balanced and thus the total stay time may be shortened.

Furthermore, the filter (47) is a non-woven sintered metal fabric instead of metal powders in the spinning pack apparatus employed in the present invention, and thus a change of the fiber properties according to the passage of time can be prevented.

The dispersing plate (44) of the present invention can have one or more grooves formed around the outer circumference as occasion demands, and it is preferable that the grooves are arranged at the same intervals. The grooves make it easy to flow the molten polymer.

By applying the spinning pack having such construction, it is possible to make the fluidity of the polymer in the spinning pack uniform, and it is also possible to improve the spinning property according to the high pressure spinning because the pack raises the rear pressure of the die.

The polymer extruded from the die is quenched through a delayed quenching zone that is composed of a combination of a hood-heater (H/H) and a heat insulating plate in order to lower the spinning tension and lessen the thermal history. At this time, the temperature of the hood-heater (H/H) is preferably 200 to 350° C. and its length is preferably 100 to 400 mm, and the length of the heat insulating plate is preferably 70 to 400 mm. The stay time of the extruded polymer in the delayed quenching zone is preferably 0.01 to 0.1 sec., and more preferably 0.02 to 0.08 sec.

When the temperature of the hood-heater is less than 200° C. and its length is less than 100 mm, the drawability deteriorates and the spinning becomes difficult, and when the temperature is over 350° C. and the length is over 400 mm, the tenacity deteriorates because the degradation of the polyester occurs, and the stability of the flat shape falls because the elasticity of the molten polyester decreases. Furthermore, when the length of the heat insulating plate is less than 70 mm, fluff is generated because the drawability falls, and when the length is over 400 mm, the spinning tension decreases rapidly and the winding becomes difficult because the solidifying point decreases excessively. When the stay time in the delayed quenching zone is less than 0.01 sec., it is difficult to carry out the delayed quenching and it is also difficult to secure the drawability because the birefringence index of the undrawn fiber is high, and when the time is over 0.1 sec., the operation is difficult owing to the generation of the fluff and the fiber breakage because of the generation of the fiber deviation and the vortex flow caused by the deterioration of the tension of the undrawn fiber extruded from the die, and it is also difficult to obtain the required cross-section of the fiber because of the excessive deterioration of the elasticity of the molten polyester.

The polyester fiber having undergone the quenching process is provided with spinning oil by passing it through an oiling roller. Any one that is used in the process for preparing the common polyester fiber can be used, and preferably a spinning oil that is one or a mixture of two or more selected from an ethyleneoxide/propyleneoxide attached diol ester, an ethyleneoxide attached diol ester, a glyceryl triester, a trymethylpropane triester, or other ethyleneoxide adducts is used, and the spinning oil may further include an antistatic agent and the like. However, the kinds of the spinning oil of the present invention are not limited to the above examples.

The polyester fiber provided with the spinning oil is drawn through a drawing apparatus after passing through the pre-interlacer, and the drawing condition can follow the drawing method of the common polyester fiber.

Then, it is possible to pass the polyester fiber through the pre-interlacer as is, or it is also possible to selectively provide interlacing air having a direction in a certain range to the pre-interlacer.

When the interlacing air is provided to the pre-interlacer, the present invention provides the polyester fiber having the above-mentioned properties, and also makes it possible to provide a polyester fiber having particular properties in which the crystallinity is from 35 to 52%, the tensile strength is from 7.0 to 10.0 g/d, the elongation at break is from 12 to 30%, through the post-drawing process explained hereinafter.

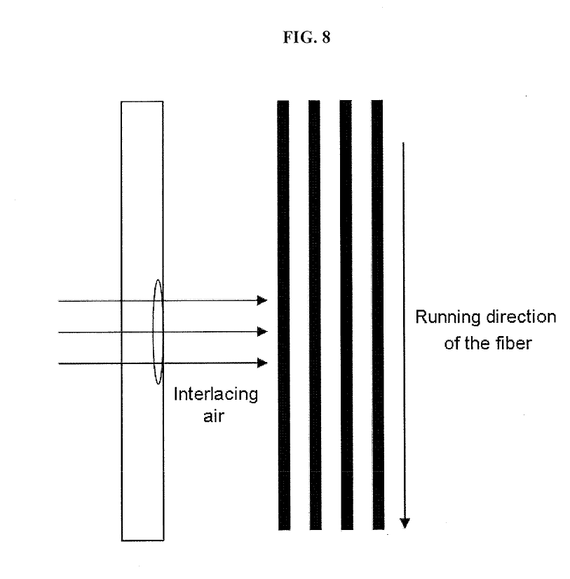

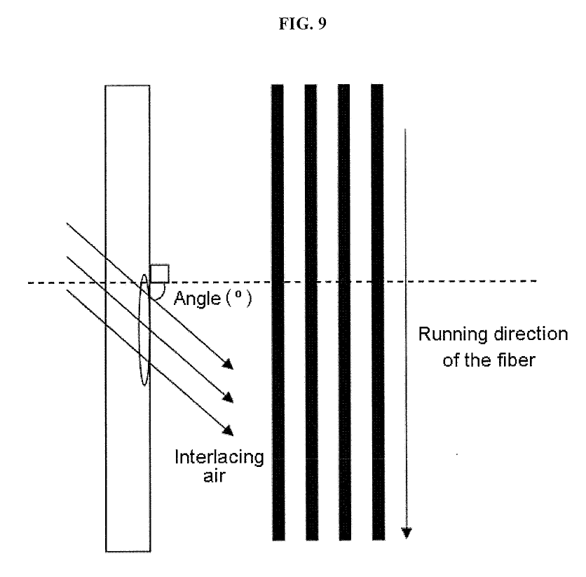

As the method to provide interlacing air to the pre-interlacer, it is possible to provide the interlacing air to the pre-interlacer in the direction perpendicular to the running direction of the fiber as illustrated in FIG. 8, and it is also possible to provide the interlacing air to the pre-interlacer in an inclined direction with respect to the running direction of the fiber as illustrated in FIG. 9. Since the cross-section of the undrawn fiber is flat, it is more preferable to provide the air to the pre-interlacer in the inclined direction with respect to the running direction of the fiber according to FIG. 9 in order to prevent the vortex flow of the undrawn fiber caused by the air, and it is most preferable that the direction of the interlacing air has an angle of 0° to 80° from the plane perpendicular to the running direction of the fiber.

Furthermore, it is preferable that the pressure of the interlacing air is 0.1 kg/cm² or more in order to gather the undrawn fiber in order and improve the drawability while migrating the oil provided to the undrawn fiber uniformly, and it is also preferable that the pressure is 1.5 kg/cm² or less in order to prevent the deterioration of the drawability caused by the excessive interlacing of the undrawn fiber.

In the spinning process, when the spinning speed is below 400 m/min, the quality of the fiber falls owing to fiber deviation, and when the speed is over 900 m/min, the workability is reduced because of the generation of the fluff.

Furthermore, the drawing ratio is preferably 4.5 to 6.2 times, because it is difficult to have the required property of the high tenacity when the drawing ratio of the spinning process is less than 4.5 times, and the quality of the fiber falls because of the generation of the fluff when the ratio is over 6.2 times. The drawing process of the present invention is accomplished by pre-drawing that is carried out between the apparatuses 141 and 142 of FIG. 2, the first drawing step that is carried out between the apparatuses 142 and 143, and the second drawing step that is carried out between the apparatuses 143 and 144 in order to secure the uniform drawability between the monofilaments, and the drawing ratio of the pre-drawing is preferably 1.01 to 1.1 and the drawing ratio of the first drawing step is preferably 60 to 85% of the total drawing ratio.

When the temperature of the heat treating carried out at the drawing apparatus 144 is less than 215° C., the shape stability deteriorates because of the increase of the shrinkage rate, and when the temperature is over 250° C., the fiber breakage and tar on the godet rollers appears frequently and the workability decreases. Therefore, the heat treating temperature is preferably 215 to 250° C., and more preferably 220 to 245° C.

When the relaxing rate of the drawing process carried out at the multi-step drawing apparatus 144 to 146 is less than 4%, the cross-section of the fiber may be distorted by the excessive tension, and when it is over 13%, the working is difficult because the fiber deviation occurs excessively at the godet rollers. Therefore, the relaxing rate is preferably 4 to 13% and the relaxing temperature is preferably 150 to 245° C.

Furthermore, the present invention makes it possible to interlace the fiber by applying the second interlacer to the drawn polyester fiber again.

The second interlacer provides the intermingling of the polyester fiber by using the air pressure. The second interlacer improves the deterioration of the cohesion factor according to the decrease of air pressure of a usual interlacer, and performs a role to intermingle uniformly along the length direction (or the running direction) of the fiber.

The second interlacer may be located alone or together beyond the winder or between the godet rollers (correspond to 141 to 146 of FIG. 2), which are the drawing apparatuses, the interlacing air can be provided in the inclined direction to the running direction of the fibers as illustrated in FIG. 9, and it is preferable that the direction of the interlacing air has an angle of 20° to 80° from the plane perpendicular to the running direction of the fiber. At this time, the air pressure is also preferably 0.1 to 4 kg/cm².

When the air pressure is less than 0.1 kg/cm², it is insufficient to provide the fiber with the cohesion factor, and consequently it causes a decrease of the combining factor, disorder of winding, and generation of the fluff. Furthermore, when the air pressure is over 4.0 kg/cm², there are too many strong intermingles between the filaments of the fiber (or too big CFP(Cohesion Factor by Pin)) it is difficult to obtain the required smoothness, and the degree of irregularity in regard to the length direction of the fiber is large.

The second interlacer can be applied continuously with multi-steps in order to increase the number of micro-intermingles. In case of the multi-steps, the interlacer is preferably equipped with 2 ea or more, more preferably 2 to 4 ea, continuously. When the second interlacer is equipped with multi-steps, it is preferable that the number of steps of the multi-interlacer is at most 4 ea, because its installation is difficult and the workability decreases when the number of multi-steps of the interlacer is 5 ea or more.

In particular, the interlacing air in the pre-interlacer and the second interlacer may be provided in the inclined direction to the running direction of the fibers, and the processing workability for preparing the airbag fabric of the present invention can be effectively improved. It is possible to improve the product qualities of the polyester fiber and the airbag fiber by reducing the generation of the fluff and improving the surface smoothness, as well as to improve the yield of the post-process to achieve the economic advantages.

The polyester fiber having passed through the second interlacer is wound by a winder, and then the polyester fiber used for the airbag fabric of the present invention is finally prepared.

Furthermore, the present method of the polyester fiber may further include a process of providing after-oil by equipping an after-oiling apparatus between the second interlacer and the winder in order to improve the workability of the post-process by improving the antistatic property and the cohesion factor of the fiber.

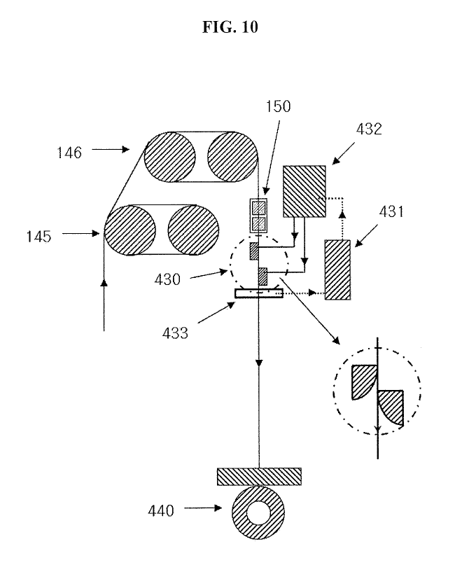

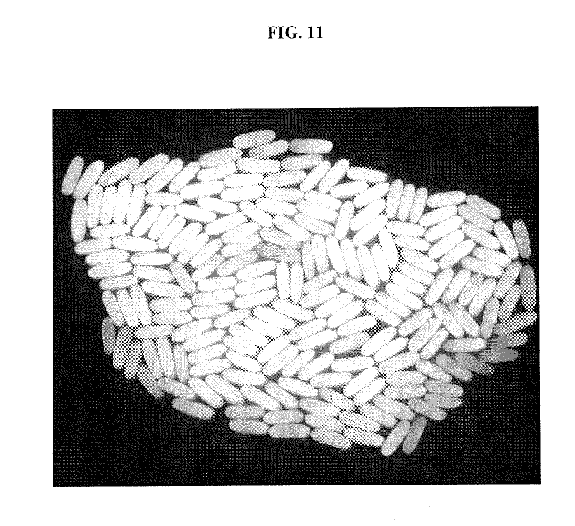

FIG. 10 is a schematic process diagram showing a case of applying the second interlacer with multi-steps of two or more steps and using an after-oiling apparatus together. As shown in FIG. 10, the second interlacer (150) is located after the drawing apparatuses (145, 146) of the polyester fiber. Also, the after-oiling apparatus (430) is a jet-guide type and is installed up and down or right and left with respect to the running direction of the fiber, and it performs a role of applying the after-oil to the fiber.

As an auxiliary apparatus of the after-oiling apparatus, an oil bath (431) for keeping the after-oil, a metering-pump (432) for sending the oil to the after-oiling apparatus in a fixed quantity, and an oil collecting bath (433) that collects oil having dripped from the after-oiling apparatus, transfers and recirculates the oil to the oil bath, and performs a role of antipollution and the like of the winder (440) are included.

The amount of oil provided in the after-oiling process is preferably 0.1 to 2.0 wt % of the weight of the polyester fiber. When the amount of oil is less than 0.1 wt %, the improving effect of the cohesion factor and the antistatic property required of the polyester fiber is insignificant, and when the amount is over 2.0 wt %, contamination by the oil may occur and it may also reduce the adhesive strength when it is applied to a coated fabric.

After-oils for the normal polyester fiber can be used as the present after-oil. The after-oil is distinguished from the oil provided before the drawing process, and may be an after-oil containing a polyol-polyalkylate as the main component, a polyoxyethylene alkyl ether, an antioxidant, an antistatic agent, and the like.

The preparation method of the polyester fiber may further apply tension guides after the relaxing process (between 145 to 146 in FIG. 2) in order to prevent overlapping of the monofilaments caused by fiber deviation during the relaxing process (between 144 and 146 in FIG. 2).

The fabric for an airbag of the present invention may be prepared from the polyester fiber with ordinary weaving process, scouring, tentering process, and coating process with the silicone resin, etc. The coated fabric may be carried out through cutting process and sewing process to prepare an airbag having a determined shape, which is usually used in an airbag, and the shape of the airbag is not limited to the above-mentioned materials.

Furthermore, the present invention provides an airbag system comprising the airbag. The airbag system may have the usual device that is well-known to the people skilled in the art. The airbag prepared by using the fabric of the present invention may be a frontal airbag or a side curtain airbag. The frontal airbag may be applied for a drive seat or a passenger seat, or may be used for a side protection, a knee protection, an ankle protection, and a walker protection, etc. The side curtain airbag may be installed in a side window or side car frames to prevent passengers from colliding with side windows or car frames at rollover.

The matters except that disclosed above are not particularly limited because they may be added or subtracted according to the necessity in the present invention.

Hereinafter, preferable examples of the present invention are presented. However, the following examples are only for illustrating the present invention and the present invention is not limited to or by them.

### EXAMPLES

### Examples 1 to 7

1) Preparation of Polyester Fibers

Solid state polymerized polyester chips having intrinsic viscosity (IV) of 0.85 g/dL were melted and extruded through slit-shaped spinning capillaries at a spinning temperature of 285° C.

Delayed quenching of the extruded molten polyester was carried out by passing through a delayed quenching zone composed of a hood-heater and a heat insulating plate.

The quenched polyester fiber was provided with spinning oil by using a roll-shaped oiling apparatus. At this time, the amount of oil was 0.8 parts by weight per 100 parts by weight of the fiber, and the spinning oil, in which an ethylene oxide/propylene oxide attached diol ester (30 parts by weight), an ethylene oxide attached diol ester (15 parts by weight), a glyceryl triester (10 parts by weight), a trimethyl propane triester (10 parts by weight), and a small quantity of an antistatic agent were mixed, was used.

The fiber provided with the oil was passed through the pre-interlacer and drawn by godet rollers.

After the drawing process, the intermingling of the drawn fiber was performed by a second interlacer and the polyester fiber was finally prepared by winding it with a winder.

The conditions of the examples of the present invention, such as the shape and the flatness of the capillaries of the spinning die, the shear rate (sec⁻¹) at the die, the construction of the applied spinning pack, the temperature and length of the hood-heater, the length of the heat insulating plate, the stay time at the delayed quenching zone, the spinning speed, the relaxing rate, the temperature of the heat treating, and so on, are listed in the following Table 1. Furthermore, the shape of the spinning pack is not particularly limited, but the polyester fiber a preferably prepared by applying the spinning pack having the shape of FIG. 5.

2) Preparation of a Fabric for an Airbag Comprising the Polyester Fiber

The fabric for the airbag was prepared by using the polyester fiber as prepared above. Firstly, the plain fabric for the airbag was weaved with the polyester fiber in a Rapier loom. At this time, the warp density and the weft density were the same each other in order to achieve the air permeability sufficient for an airbag fabric, and the total fineness, the number of filaments, and the weaving density are listed in the following Table 1.

Two solution baths comprising a water with sodium hydroxide 1.5 g/L, a surfactant 1.08 g/L, a wetting agent 1.08 g/L, and a dispersion agent 1.25 g/L was maintained at the temperature of 75° C. Two washing baths of 80° C. and 85° C., respectively, were equipped with each of the solution baths continuously.

Then, the plain fabric for the airbag was passed through the first solution bath and two washing baths continuously, and was passed through the second solution bath and two washing baths continuously.

After that, the plain fabric for the airbag was dehydrated and dried with an air of 110° C. to remove the remaining water to prepare a non-coating fabric for the airbag.

The non-coating fabric, which went through scouring and heat setting process, was coated with polyvinylchloride (PVC) resin by knife over roll coating method to prepare the PVC coated fabric for the airbag.

### Comparative Example 1

The fabric for the airbag was prepared according to the same method as in Example 1, except that the polyester fiber was prepared according to several conditions of the following Table 1.

TABLE 1

| | | | | | | | | Comparative |
|---|---|---|---|---|---|---|---|---|
| | Examples | | | | | | | Example |
| | 1 | 2 | 3 | 4 | 5 | 6 | 7 | 1 |
| IV of chips | 0.85 | 1.15 | 0.95 | 1.01 | 0.90 | 0.85 | 0.90 | 0.85 |
| (dl/g) | | | | | | | | |
| Capillary shape | Slit | Slit | Slit | Slit | Slit | Slit | Slit | Circle |
| of the die | | | | | | | | |
| Die flatness | 3 | 2 | 6 | 4 | 4 | 4 | 3 | 1 |
| H/H | 250 | 350 | 210 | 300 | 280 | 280 | 300 | 250 |
| Temperature | | | | | | | | |
| (□) | | | | | | | | |
| H/H Length | 300 | 200 | 100 | 300 | 300 | 400 | 300 | 300 |
| (mm) | | | | | | | | |
| Heat insulating | 70 | 300 | 70 | 70 | 400 | 100 | 70 | 70 |
| plate length | | | | | | | | |
| (mm) | | | | | | | | |
| Stay time in | 0.037 | 0.067 | 0.015 | 0.044 | 0.049 | 0.055 | 0.037 | 0.037 |
| the delayed | | | | | | | | |
| zone | | | | | | | | |
| (sec.) | | | | | | | | |
| Spinning speed | 600 | 450 | 700 | 500 | 850 | 550 | 600 | 600 |
| (m/min) | | | | | | | | |
| Drawing ratio | 5.5 | 6.0 | 5.3 | 5.6 | 4.7 | 5.6 | 5.4 | 5.5 |
| (times) | | | | | | | | |
| Relaxing rate | 8.0 | 11.5 | 7.5 | 6.5 | 5.0 | 9.0 | 12.0 | 9.0 |
| (%) | | | | | | | | |
| Heat treating | 240 | 247 | 247 | 240 | 230 | 240 | 220 | 240 |
| temperature | | | | | | | | |
| (□) | | | | | | | | |
| Relaxing | 220 | 240 | 200 | 160 | 180 | 220 | 240 | 220 |
| temperature | | | | | | | | |
| (□) | | | | | | | | |
| Fineness of the | 2.6 | 2.6 | 3.5 | 10.9 | 5.2 | 5.2 | 5.2 | 5.2 |
| monofilament | | | | | | | | |
| Total Fineness | 500 | 500 | 500 | 500 | 500 | 500 | 500 | 500 |
| Number of | 192 | 192 | 144 | 46 | 96 | 96 | 96 | 96 |
| filaments | | | | | | | | |
| Density | 49 × 49 | 49 × 49 | 49 × 49 | 49 × 49 | 49 × 49 | 49 × 49 | 49 × 49 | 49 × 49 |
| (weft × warp, | | | | | | | | |
| yarns/inch) | | | | | | | | |
| Amount of | 20 | 20 | 20 | 20 | 20 | 20 | 20 | 20 |
| Coating | | | | | | | | |
| (g/m²) | | | | | | | | |

### Experimental Example 1

With regard to the polyester fibers prepared according to Examples 1 to 7 and Comparative Example 1, the flatness, the shrinkage stress, the shrinkage rate, the intrinsic viscosity, the tensile strength, the elongation at break, the cross-sectional shape index of the fiber (R1, H1, R1/H1, and CV %), the yield of the post-process, the processing workability (F/D) were measured by the following methods. Also, regarding the fabric for the airbag prepared by using the polyester fibers, the thickness, the tensile strength, the tearing strength, and the air permeability were measured by the following methods. The measured properties of each fiber and fabric are listed in the following Table 2, and a cross-sectional photograph of the flat fiber prepared according to Example 1 is illustrated in FIG. 11.

1) Flatness

The flatness of the polyester fiber represents the planiform degree of the cross-section of the fiber, and the flatness of the fiber was obtained by cutting the fiber with a copperplate, magnifying the cross-section with an optical microscope and measuring the longest length (W) and the shortest length (D) of the cross-section of the fiber, and calculating the flatness of monofilament according to the following Calculation Formula 1 and taking an average of the total filaments.

The flatness of monofilament (Fᵢ)=W/D,

The flatness of the fiber=(The sum of the flatness of monofilament)/(number of the monofilament). [Calculation Formula 1]

2) Coefficient of Variation of R1, R2, R3, and R4 (CV %)

From the cross-sectional photograph of the fiber magnified by the optical microscope, R1, R2, R3, and R4 of the monofilament were measured as illustrated in FIG. 1 and their average and standard deviation were calculated according to the following Calculation Formula 2, and then the coefficient of variation (CV %) was obtained according to the following Calculation Formula 3.

Average (R)=The sum (R1+R2+R3+R4) of the total filaments/(4×n) [Calculation Formula 2]

wherein n is the total number of measured filaments, and R is the average value of R1, R2, R3, and R4 of the total filaments.

Coefficient of Variation (CV %)=Standard deviation (σ)/Average (R)×100(%) [Calculation Formula 3]

3) Average and Standard Deviation of R1/H1, R2/H2, R3/H3, and R4/H4

R1, R2, R3, and R4, and H1, H2, H3, and H4 of FIG. 1 were measured from the cross-sectional photograph of the fiber magnified by the optical microscope, the average and the standard deviation of R1/H1, R2/H2, R3/H3, and R4/H4 of the total filaments were calculated according to the following Calculation Formula 4, and then the coefficient of variation (CV %) was obtained according to Calculation Formula 3.

Average (R/H)=The sum (R1/H1+R2/H2+R3/H3+R4/H4) of the total filaments/(4×n) [Calculation Formula 4]

wherein n is the total number of the measured filaments, and R/H is the average value of R1/H1, R2/H2, R3/H3, and R4/H4 of the total filaments.

4) Shrinkage Stress (g/d)

The shrinkage stress was measured by using a thermal stress tester (Kanebo Co.) at 150° C. and 200° C., respectively, while elevating the temperature with a scan speed of 2.5° C./sec under an initial load of 0.1 g/d. The specimen was prepared by knotting in the form of loop.

$$[ Calculation Formula 5 ]$$

$$Thermal stress ( g / d ) = \frac{Measured Thermal Stress ( g )}{Fineness of the Fiber ( d ) \times 2}$$

5) Shrinkage Rate (%)

The shrinkage rate is a value representing a percentage of the change of the length of the specimen by heat at a specific temperature, and it is defined according to the following Calculation Formula 6.

Shrinkage rate (%)={(L₀−L₁)/L₀}×100 [Calculation Formula 6]

wherein L₀ is the length of the specimen before the thermal shrinking, and L₁ is the length of the specimen after the thermal shrinking.

After fixing the fiber under a regular load of 0.01 g/d, the shrinkage rate was measured by the Testrite MK-V (Testrite Co.), and the measuring condition was based on a state of being left under a load of 0.01 g/d at 190° C. for 15 minutes.

6) Intrinsic Viscosity of the Fiber

After extracting the spinning oil from the specimen with carbon tetrachloride and dissolving the specimen in ortho-chlorophenol at 160±2° C., the viscosity of the specimen was measured in a capillary by using an automatic viscometer (Skyvis-4000) at a temperature of 25° C., and the intrinsic viscosity (IV) of the fiber was calculated according to the following Calculation Formula 7.

Intrinsic Viscosity (IV)={(0.0242×Rel)+0.2634}×F [Calculation Formula 7]

wherein,

Rel=(seconds of solution×specific gravity of solution×viscosity coefficient)/(OCP viscosity), and

F=IV of the standard chip/average of three IV measured from the standard chip with standard action.

7) Tensile Strength (g/d), Elongation at Break (%)

The tensile strength and the elongation at break of the polyester fiber were measured by a universal testing machine (UTM, Instron Co.), and the length of the specimen was 250 mm, the extending speed was 300 mm/min., and the initial load was 0.05 g/d.

8) Processing Workability (F/D)

As an index representing the productivity of the fiber, the portion of the full-cheese doffing number to the total doffing number was calculated according to the following Calculation Formula 8.

$$[ Calculation Formula 8 ]$$

$$F / D ( \% ) = \frac{Number of Full Cheese Doffing}{\begin{matrix}Number of Full Cheease Doffing + \\ Number of Cheese Doffing\end{matrix}} \times 100$$

9) Number of Warper Fluffs (ea/10⁶ m)

The number of warper fluffs was calculated by converting the number of check times of a Fluff-Detector to 10⁶ m scale.

10) Yield of the Post-Process

The percentage of the normal products to the total input of the fibers was calculated according to the following Calculation Formula 9.

Yield of the post-process=quantity of normal products/total input of fibers×100 [Calculation Formula 9]

11) Thickness of the coated fabrics

After measuring the thickness of the coated fabrics prepared by Examples 1 to 7 and Comparative Example 1, the thickness (T) of fabrics prepared by Examples 1 to 7 was divided by the thickness (t) of the fabric prepared by Comparative Example 1, and the percentage thereof was calculated according to the following Calculation Formula 10.

Thickness of fabric (%, relative value)=T/t×100 [Calculation Formula 10]

12) Tensile Strength

A sample was made from each fabric prepared by Examples 1 to 7 and Comparative Example 1, and the tensile strength of the fabric sample was measured according to the assessment of ASTM D5034. The fabric sample was set to the lower clamp of the apparatus according to the assessment of ASTM D5034 and the upper clamp of the apparatus was moving in the upper direction. Then, the tensile strength of the fabric sample was measured when the fabric sample was cut.

13) Tearing Strength

A sample having an opening part of 7 cm in weft or warp directions was made from each fabric prepared by Examples 1 to 7 and Comparative Example 1, and the tearing strength of the fabric sample was measured according to the assessment of ASTM D2261. The fabric sample, which the opening part was centered therein, was set to the left and right clamps of the apparatus according to the assessment of ASTM D2261 and the clamps were moving in the opposite directions, i.e., the upper and lower directions, respectively. Then, the tearing strength of the fabric sample was measured when the fabric sample was torn.

14) Air Permeability

According to the assessment of ASTM D1338, each fabric prepared by Examples 1 to 7 and Comparative Example 1 was stored in the atmosphere of 65% RH at 2° C., and then the air permeability of the fabric was measured by passing the air having 125 Pa through a circle part of the fabric having 38 cm².

TABLE 2

| | | | | | | | | Comparative |
|---|---|---|---|---|---|---|---|---|
| | Examples | | | | | | | Example |
| | 1 | 2 | 3 | 4 | 5 | 6 | 7 | 1 |
| Flatness | 2.6 | 1.3 | 3.0 | 2.8 | 2.8 | 2.5 | 2.2 | 1 |
| CV of R | 10.2 | 6.4 | 15.7 | 11.3 | 10.7 | 9.4 | 5.7 | — |
| (CV %) | | | | | | | | |
| Average of R/H | 0.62 | 0.41 | 0.88 | 0.78 | 0.72 | 0.65 | 0.70 | 0.41 |
| CV of R/H | 11.5 | 7.8 | 17.8 | 12.7 | 11.3 | 10.3 | 6.5 | — |
| (CV %) | | | | | | | | |
| Shrinkage stress | 0.022 | 0.009 | 0.012 | 0.035 | 0.067 | 0.035 | 0.043 | 0.025 |
| (@150° C., g/d) | | | | | | | | |
| Shrinkage stress | 0.031 | 0.012 | 0.020 | 0.041 | 0.074 | 0.043 | 0.055 | 0.037 |
| (@200° C., g/d) | | | | | | | | |
| Shrinkage rate | 2.7 | 1.8 | 3.6 | 4.3 | 5.5 | 3.5 | 4.7 | 3.0 |
| (%) | | | | | | | | |
| Intrinsic viscosity | 0.81 | 0.99 | 0.90 | 0.93 | 0.88 | 0.81 | 0.84 | 0.80 |
| of the fiber | | | | | | | | |
| (dl/g) | | | | | | | | |
| Tensile strength of | 8.2 | 8.8 | 7.8 | 9.0 | 9.2 | 8.5 | 8.0 | 8.0 |
| the fiber | | | | | | | | |
| (g/d) | | | | | | | | |
| Elongation at | 25.7 | 23.7 | 29.8 | 20.5 | 17.5 | 24.5 | 27.0 | 27.6 |
| break | | | | | | | | |
| (%) | | | | | | | | |
| Workability | 95.1 | 98.0 | 96.8 | 95.2 | 95.2 | 91.0 | 92.7 | 95.0 |
| (F/D rate, %) | | | | | | | | |
| Number of warper | 2.1 | 1.1 | 1.9 | 1.7 | 2.1 | 2.7 | 2.4 | 1.9 |
| fluffs | | | | | | | | |
| (EA/10⁶ m) | | | | | | | | |
| Yield of the post- | 97.2 | 98.5 | 97.9 | 98.0 | 97.7 | 94.5 | 96.7 | 96.3 |
| process | | | | | | | | |
| (%) | | | | | | | | |
| Thickness of the | 85.3 | 92.0 | 72.0 | 82.1 | 84.2 | 87.5 | 88.5 | 100 |
| coated fabric | | | | | | | | |
| (%) | | | | | | | | |
| Tensile strength of | 249 | 261 | 245 | 265 | 270 | 257 | 253 | 252 |
| the fabric | | | | | | | | |
| (kgf/inch) | | | | | | | | |
| Tearing strength of | 41 | 45 | 40 | 46 | 48 | 44 | 42 | 42 |
| the fabric | | | | | | | | |
| (kgf) | | | | | | | | |
| Air Permeability | 0.7 | 3.0 | 0 | 0.5 | 0.5 | 0.9 | 1.2 | 11.2 |
| of the fabric | | | | | | | | |
| (cfm) | | | | | | | | |

As shown in Table 2, the present fabrics for the airbag prepared according to Examples 1 to 7 are not only superior in thermal shape stability owing to the low shrinkage stress and low shrinkage rate, but are also superior in the folding property by lowering the thickness of the coated fabric owing to the uniformity of the flat shape of the cross-section of the polyester fibers. Also, they are superior in tensile strength, tearing strength, and air permeability. On the other hand, the fabric prepared from the conventional polyester fiber having the circular cross-section according to Comparative Example 1 possess the tensile strength and tearing strength similar to those of the fabrics of Examples 1 to 7, but air permeability thereof was considerably deteriorated.

### Examples 8 to 14 and Comparative Example 2

### 1) Preparation of Polyester Fibers

Solid state polymerized polyester chips having the intrinsic viscosity (IV) of 0.85 g/dL were melted and extruded through the slit-shaped spinning capillaries of 285° C.

The delayed quenching of the extruded molten polyester was carried out by passing through the delayed quenching zone composed of the hood-heater and the heat insulating plate.

The quenched polyester fiber was provided with spinning oil by using the roll-shaped oiling apparatus. At this time, the amount of oil was 0.8 parts by weight per 100 parts by weight of the fiber, and the spinning oil, in which an ethylene oxide/propylene oxide attached diol ester (30 parts by weight), an ethylene oxide attached diol ester (15 parts by weight), a glyceryl triester (10 parts by weight), a trimethyl propane triester (10 parts by weight), and a small quantity of an antistatic agent were mixed, was used.

The fiber provided with the oil was passed through the pre-interlacer of FIG. 9 and drawn by the godet rollers.

After the drawing process, the intermingling of the drawn fiber was performed by using the second interlacer of FIG. 9.

After-oil was provided to the polyester fiber having passed through the interlacer by using the after-oiling apparatus of a jet-guide type. At this time, the amount of after-oil was 0.7 parts by weight per 100 parts by weight of the fiber, and the after-oil, in which a polyol-polyalkylate (70 parts by weight), a polyoxyethylene alkylether (20 parts by weight), an antioxidant (2 parts by weight), and an antistatic agent (2 parts by weight) were mixed, was used.

After the after-oiling process, the polyester fiber was finally prepared by winding it with the winder

The conditions of the examples of the present invention, such as the shape and flatness of the capillaries of the spinning die, the temperature and length of the hood-heater, the length of the heat insulating plate, the stay time at the delayed quenching zone, the direction and the pressure of the air of the pre-interlacer, the spinning speed, the drawing ratio (the drawing ratio of the pre-drawing, and the drawing rate of the 1^{st} step of drawing compared to the total drawing ratio), the relaxing rate, the temperature of the heat treating, the number of the second interlacer, the direction and the pressure of the air, provision or not of the oil and the after-oil, and so on, are listed in the following Table 3.

The direction of the air of the interlacer means the angle of the jetted air based on the perpendicular direction with respect to the running direction of the fiber as illustrated in FIG. 9. That is, 0° means perpendicular to the running direction of the fiber, and 90° means parallel with the running direction of the fiber.

2) Preparation of a Fabric for an Airbag Comprising the Polyester Fiber

The fabric for the airbag was prepared by using the polyester fiber as prepared above. Firstly, the plain fabric for the airbag was weaved with the polyester fiber in a Rapier loom. At this time, the warp density and the weft density were the same each other in order to achieve the air permeability sufficient for an airbag fabric, and the total fineness, the number of filaments, and the weaving density are listed in the following Table 3.

Two solution baths comprising a water with sodium hydroxide 1.5 g/L, a surfactant 1.08 g/L, a wetting agent 1.08 g/L, and a dispersion agent 1.25 g/L was maintained at the temperature of 75° C. Two washing baths of 80° C. and 85° C., respectively, were equipped with each of the solution baths continuously.

Then, the plain fabric for the airbag was passed through the first solution bath and two washing baths continuously, and was passed through the second solution bath and two washing baths continuously.

After that, the plain fabric for the airbag was dehydrated and dried with an air of 110° C. to remove the remaining water to prepare a non-coating fabric for the airbag.

The non-coating fabric, which went through scouring and heat setting process, was coated with polyvinylchloride (PVC) resin by knife over roll coating method to prepare the PVC coated fabric for the airbag.

TABLE 3

| | | | | | | | | Comparative |
|---|---|---|---|---|---|---|---|---|
| | Examples | | | | | | | Example |
| | 8 | 9 | 10 | 11 | 12 | 13 | 14 | 2 |
| IV of chips | 0.85 | 1.15 | 0.95 | 1.01 | 0.90 | 0.85 | 0.90 | 0.90 |
| (dl/g) | | | | | | | | |
| Capillary shape | Slit | Slit | Slit | Slit | Slit | Slit | Slit | Circle |
| of the die | | | | | | | | |
| Die flatness | 3 | 2 | 6 | 4 | 4 | 4 | 3 | 1 |
| H/H | 250 | 350 | 210 | 300 | 280 | 280 | 300 | 300 |
| Temperature | | | | | | | | |
| (□) | | | | | | | | |
| H/H Length | 300 | 200 | 100 | 300 | 300 | 400 | 300 | 300 |
| (mm) | | | | | | | | |
| Heat insulating | 70 | 300 | 70 | 70 | 400 | 100 | 70 | 70 |
| plate length | | | | | | | | |
| (mm) | | | | | | | | |
| Stay time in the | 0.037 | 0.067 | 0.015 | 0.044 | 0.049 | 0.055 | 0.037 | 0.037 |
| delayed zone | | | | | | | | |
| (sec) | | | | | | | | |
| Air direction of | 45 | 60 | 80 | 30 | 60 | 0 | 0 | 60 |
| the pre-interlacer | | | | | | | | |
| (°) | | | | | | | | |
| Air pressure of | 0.7 | 1.0 | 1.4 | 0.4 | 0.8 | 0.7 | 0.4 | 0.7 |
| the pre-interlacer | | | | | | | | |
| (kg/cm²) | | | | | | | | |
| Spinning speed | 600 | 450 | 700 | 500 | 850 | 550 | 600 | 600 |
| (m/min) | | | | | | | | |
| Drawing ratio | 5.5 | 6.0 | 5.3 | 5.6 | 4.7 | 5.6 | 5.4 | 5.5 |
| (times) | | | | | | | | |
| Pre-drawing | 1.02 | 1.08 | 1.03 | 1.02 | 1.02 | 1.05 | 1.02 | 1.02 |
| ratio | | | | | | | | |
| (times) | | | | | | | | |
| The 1^{st} drawing | 71 | 62 | 76 | 79 | 78 | 69 | 74 | 74 |
| rate compared to | | | | | | | | |
| the total drawing | | | | | | | | |
| ratio (%) | | | | | | | | |
| Relaxing rate | 8.0 | 11.5 | 7.5 | 6.5 | 5.0 | 9.0 | 12.0 | 8.0 |
| (%) | | | | | | | | |
| Heat treating | 240 | 247 | 247 | 240 | 230 | 240 | 220 | 245 |
| temperature | | | | | | | | |
| (□) | | | | | | | | |
| Relaxing | 220 | 240 | 200 | 160 | 180 | 220 | 240 | 240 |
| temperature | | | | | | | | |
| (□) | | | | | | | | |
| Number of 2^{nd} | 1 | 2 | 2 | 1 | 3 | 2 | 1 | 1 |
| interlacer | | | | | | | | |
| Air direction of | 80 | 60 | 80 | 30 | 60 | 0 | 60 | 60 |
| the 2^{nd} interlacer | | | | | | | | |
| (°) | | | | | | | | |
| Air pressure of | 3.5 | 0.8 | 2.0 | 1.0 | 0.5 | 2.0 | 0.8 | 2.5 |
| the 2^{nd} interlacer | | | | | | | | |
| (kg/cm²) | | | | | | | | |
| Provision or not | Applied | Not | Applied | Applied | Not | Applied | Applied | Applied |
| of the after-oil | | applied | | | applied | | | |
| Content of after- | 0.7/0.8 | 0/0.8 | 0.3/0.8 | 1.2/0.8 | 0/0.8 | 1.7/0.8 | 0.7/0.8 | 0.7/0.8 |
| oil/oil | | | | | | | | |
| (parts by weight) | | | | | | | | |
| Fineness of the | 2.6 | 2.6 | 3.5 | 10.9 | 5.2 | 5.2 | 5.2 | 5.2 |
| monofilament | | | | | | | | |
| Total Fineness | 500 | 500 | 500 | 500 | 500 | 500 | 500 | 500 |
| Number of | 192 | 192 | 144 | 46 | 96 | 96 | 96 | 96 |
| filaments | | | | | | | | |
| Density | 49 × 49 | 49 × 49 | 49 × 49 | 49 × 49 | 49 × 49 | 49 × 49 | 49 × 49 | 49 × 49 |
| (weft × warp, | | | | | | | | |
| yarns/inch) | | | | | | | | |
| Amount of | 20 | 20 | 20 | 20 | 20 | 20 | 20 | 20 |
| Coating | | | | | | | | |
| (g/m²) | | | | | | | | |

### Experimental Example 2

With regard to the polyester fibers prepared according to Examples 8 to 14 and Comparative Example 2, the flatness, the shrinkage stress, the shrinkage rate, the intrinsic viscosity, the tensile strength, the elongation at break, the processing workability, the number of warper fluffs, and the thickness, the tensile strength, the tearing strength, and the air permeability of the fabric for the airbag prepared by using the polyester fibers were measured according to the above methods. Furthermore, the crystallinity of the polyester fibers was measured by the following methods.

At this time, the thickness of fabrics prepared by Examples 8 to 14 represents a percentage, which is calculated according to the above Calculation Formula 10, with regard to the thickness of the fabric prepared by Comparative Example 2 instead of Comparative Example 1.

The measured properties of each fiber and fabric are listed in the following Table 4, and a cross-sectional photograph of the flat fiber prepared according to Example 8 was obtained as in FIG. 11.

15) Crystallinity (%)

The density ρ of the polyester fiber was measured according to the density gradient method using n-heptane and carbon tetrachloride at 25° C., and the crystallinity was calculated according to the following Calculation Formula 11.

$$Xc ( crystallinity ) = \frac{{ρ}_{c} ( ρ - {ρ}_{a} )}{ρ ( {ρ}_{c} - {ρ}_{a} )} \qquad [ Calculation Formula 11 ]$$

wherein ρ is the density of the fiber, ρ_{c} is the density of a crystalline region (1.457 g/cm³ in case of PET), and ρₐ is the density of an amorphous region (1.336 g/cm³ in case of PET).

TABLE 4

| | | | | | | | | Comparative |
|---|---|---|---|---|---|---|---|---|
| | Examples | | | | | | | Example |
| | 8 | 9 | 10 | 11 | 12 | 13 | 14 | 2 |
| Flatness | 2.6 | 1.3 | 3.0 | 2.8 | 2.8 | 2.5 | 2.2 | 1 |
| CV of R | 46.5 | 51.0 | 47.1 | 45.2 | 42.7 | 45.4 | 43.3 | 44.3 |
| (CV %) | | | | | | | | |
| Average of R/H | 0.020 | 0.007 | 0.015 | 0.033 | 0.065 | 0.032 | 0.042 | 0.018 |
| CV of R/H | 0.030 | 0.010 | 0.022 | 0.039 | 0.070 | 0.041 | 0.054 | 0.027 |
| (CV %) | | | | | | | | |
| Shrinkage stress | 2.8 | 1.6 | 3.5 | 4.1 | 5.5 | 3.3 | 4.5 | 2.4 |
| (@150° C., g/d) | | | | | | | | |
| Shrinkage stress | 0.77 | 0.99 | 0.88 | 0.91 | 0.86 | 0.80 | 0.85 | 0.83 |
| (@200° C., g/d) | | | | | | | | |
| Shrinkage rate | 8.1 | 8.6 | 7.7 | 8.8 | 9.1 | 8.4 | 7.8 | 7.7 |
| (%) | | | | | | | | |
| Intrinsic | 26.7 | 24.5 | 30.0 | 21.6 | 18.5 | 25.5 | 28.1 | 28.6 |
| viscosity of the | | | | | | | | |
| fiber | | | | | | | | |
| (dl/g) | | | | | | | | |
| Tensile strength | 96.2 | 99.5 | 97.2 | 97.5 | 97.4 | 92.3 | 94.1 | 88.7 |
| of the fiber | | | | | | | | |
| (g/d) | | | | | | | | |
| Elongation at | 1.6 | 0.7 | 1.3 | 1.2 | 1.5 | 2.1 | 1.9 | 4.1 |
| break | | | | | | | | |
| (%) | | | | | | | | |
| Workability | 98.1 | 99.1 | 98.4 | 98.5 | 98.2 | 95.0 | 97.2 | 89.1 |
| (F/D rate, %) | | | | | | | | |
| Number of | 86.4 | 92.5 | 75.0 | 83.2 | 84.5 | 88.3 | 89.2 | 100 |
| warper fluffs | | | | | | | | |
| (EA/10⁶ m) | | | | | | | | |
| Yield of the | 248 | 260 | 245 | 265 | 268 | 255 | 252 | 250 |
| post-process | | | | | | | | |
| (%) | | | | | | | | |
| Thickness of the | 40 | 43 | 38 | 44 | 47 | 43 | 41 | 41 |
| coated fabric | | | | | | | | |
| (%) | | | | | | | | |
| Air Permeability | 0.7 | 3.0 | 0 | 0.5 | 0.5 | 0.9 | 1.2 | 11.2 |
| of the fabric | | | | | | | | |
| (cfm) | | | | | | | | |

As shown in Table 4, the present fabrics for the airbag prepared according to Examples 1 to 7 are not only superior in thermal shape stability owing to the low shrinkage stress and low shrinkage rate, but are also superior in the folding property by lowering the thickness of the coated fabric owing to the uniformity of the flat shape of the cross-section of the polyester fibers. Also, they are superior in tensile strength, tearing strength, and air permeability.

The polyester fiber prepared according to Examples 8 to 14 maximizes the surface smoothness by making the cross-section of the filaments flat and uniform, and it is possible to lessen the thickness of the coated fabric and contribute to lessening the weight of the product and improving the surface smoothness. Also, the coated fabric of Examples 8 to 14 can improve the processing workability and the yield of the post-process to achieve the economic advantages.

On the other hand, the fabric prepared from the conventional polyester fiber having the circular cross-section according to Comparative Example 1 possess the tensile strength and tearing strength similar to those of the fabrics of Examples 1 to 7, but air permeability thereof was considerably deteriorated.

While the present invention has been described in detail with reference to the preferred embodiments, those skilled in the art will appreciate that various modifications and substitutions can be made thereto without departing from the spirit and scope of the present invention as set forth in the appended claims

What is claimed is:

1. A fabric for an airbag comprising the polyester fiber, wherein the flatness of the cross-section of the polyester fiber is from 1.3 to 3.0 and a coefficient of variation (CV %) of R1 to R4 in the total filaments of the polyester fiber is 20% or less, with provision that both end points of the longest axis of the cross-section are defined as W1 and W2, both end points of the shortest axis perpendicularly crossing the longest axis at a center point O of the longest axis are defined as D1 and D2, a line between W1 and D1 is defined as L1, a line between D1 and W2 is defined as L2, a line between W1 and D2 is defined as L3, a line between W2 and D2 is defined as L4, a perpendicular distances from L1, L2, L3, and L4 to the farthest line of the cross-section are defined as R1, R2, R3, and R4, respectively, and a perpendicular distances from L1, L2, L3, and L4 to the center point O are defined as H1, H2, H3, and H4, respectively.

2. The fabric for an airbag according to claim 1, wherein the average of R1/H1, R2/H2, R3/H3, and R4/H4 in the total filaments of the polyester fiber is 0.2 to 0.9.

3. The fabric for an airbag according to claim 1, wherein the coefficient of variation (CV %) of R1/H1, R2/H2, R3/H3, and R4/H4 in the total filaments of the polyester fiber is 20% or less.

4. The fabric for an airbag according to claim 1, wherein shrinkage stress (@ 0.1 g/d, 2.5° C./sec) at 150° C. is from 0.005 to 0.1 g/d, shrinkage stress (@ 0.1 g/d, 2.5° C./sec) at 200° C. is from 0.005 to 0.1 g/d, and shrinkage rate (@ 190° C., 15 min, 0.01 g/d) is from 1.5% to 10.0%.

5. The fabric for an airbag according to claim 1, wherein the polyester fiber includes polyethylene terephthalate (PET) in an amount of 90 mol % or more.

6. The fabric for an airbag according to claim 5, wherein the intrinsic viscosity of the polyester fiber is from 0.7 to 1.2 dl/g.

7. The fabric for an airbag according to claim 1, wherein the tensile strength of the polyester fiber is from 7.0 to 10.0 g/d and the elongation at break is from 12% to 30%.

8. The fabric for an airbag according to claim 1, wherein the fineness of the monofilament of the polyester fiber is from 2.1 to 11.0 de.

9. A fabric for an airbag comprising the polyester fiber, wherein flatness of the cross-section of the polyester fiber is from 1.3 to 3.0, shrinkage stress (@ 0.1 g/d, 2.5° C./sec) at 150° C. is from 0.005 to 0.1 g/d, shrinkage stress (@ 0.1 g/d, 2.5° C./sec) at 200° C. is from 0.005 to 0.1 g/d, and shrinkage rate (@ 190° C., 15 min, 0.01 g/d) is from 1.5% to 10.0%.

10. The fabric for an airbag according to claim 9, wherein the polyester fiber includes polyethylene terephthalate (PET) in an amount of 90 mol % or more.

11. The fabric for an airbag according to claim 9, wherein the intrinsic viscosity of the polyester fiber is from 0.7 to 1.2 dl/g.

12. The fabric for an airbag according to claim 9, wherein the crystallinity of the polyester fiber is from 35% to 52%.

13. The fabric for an airbag according to claim 9, wherein the tensile strength of the polyester fiber is from 7.0 to 10.0 g/d and the elongation at break is from 12% to 30%.

14. The fabric for an airbag according to claim 1, further including a resin layer coated or laminated on the fabric.

15. The fabric for an airbag according to claim 14, wherein the resin layer comprises at least one selected from the group consisting of silicone resin, polyvinyl chloride resin, polyethylene resin, and polyurethane resin.

16. The fabric for an airbag according to claim 14, wherein the amount of the resin layer material coated or laminated on the fabric is 20 g/m² to 200 g/m².

17. The fabric for an airbag according to claim 1, wherein an air permeability of the fabric measured according to the assessment of ASTM D737 is 0 to 10.0 cfm.

18. A method of preparing a fabric for an airbag, comprising the steps of:
melt-spinning polyester chips through slit-typed capillaries and drawing the melt-spun fiber to prepare a polyester fiber having the flatness of the cross-section thereof from 1.3 to 3.0;
weaving a fabric with the polyester fiber;
scouring the woven fabric; and
tentering the scoured fabric.

19. The method of preparing a fabric for an airbag according to claim 18, wherein the flatness of the die is 1.2 to 10.

20. The method of preparing a fabric for an airbag according to claim 18, wherein the intrinsic viscosity of the polyester chips is from 0.7 to 1.2 dl/g.

21. The method of preparing a fabric for an airbag according to claim 18, further including a resin layer coated or laminated on the fabric.

22. The method of preparing a fabric for an airbag according to claim 18, wherein the melt-spinning step is carried out at a spinning temperature of 270 to 310° C.
